(19) United States
(12) Patent Application Publication
(10) Pub. No.: US 2022/0204893 A1
(43) Pub. Date: Jun. 30, 2022

(54) APPARATUS, PROCESS, AND EXTRUSION SCREW FOR PRODUCING SYNDET SOAPS

(71) Applicant: SOAPWORKS LIMITED, Glasgow (GB)

(72) Inventors: María del Pilar NORIEGA ESCOBAR, Santa Marta (CO); Eberhard GRUENSCHLOSS, Stuttgart (DE)

(21) Appl. No.: 17/561,485

(22) Filed: Dec. 23, 2021

Related U.S. Application Data
(60) Provisional application No. 63/130,507, filed on Dec. 24, 2020.

(51) Int. Cl. C11D 13/18; C11D 9/00; B29B 7/42

(52) U.S. Cl. CPC C11D 13/18; B29B 7/429; C11D 9/005

(57) ABSTRACT

The present disclosure is related to apparatuses, processes, and extrusion screws directed to process solid detergent compositions in shapes like billets, bars, tablets, noodles, and similar shapes produced from extruded synthetic detergents, soaps, and combinations thereof. The present disclosure describes an extrusion screw for processing synthetic detergents, soaps, and combinations thereof. The extrusion screw comprises a feed section, a metering section, and a compression section. Said compression section has a proximal channel depth adjacent to the feed section, and a distal channel depth adjacent to the metering section, and a compression ratio that may be between 2.2, and 4.1, for example, between 2.2, and 2.6. The extrusion screw may have a length to diameter ratio (L/D) that may be between 4.0, and 6.0. The present disclosure also describes an apparatus for processing synthetic detergents, soaps, and combinations thereof. The apparatus comprises a barrel and said extrusion screw. The present disclosure also describes a process for extruding solid synthetic detergents, soaps, and combinations thereof. The process comprises a step of providing a formulation that may be selected from synthetic detergent, and half-synthetic soap to said apparatus, and compressing said formulation at a temperature between 32° C., and 42° C. with a compression section of the extrusion screw. The screw rotation speed of the extrusion screw may be between 4, and 20 RPM. The formulation may be provided prewarmed. The screw rotation speed of the extrusion screw may be between 4, and 35 RPM (e.g., between 4 and 20 RPM).

### RELATED TECHNICAL FIELD

The present disclosure is related to apparatuses, processes, and extrusion screws directed to process solid detergent, and soap compositions in shapes like billets, bars, tablets, noodles, and similar shapes produced from extruded solid detergents. Especially, the present disclosure is related to apparatuses, processes, and extrusion screws for processing synthetic detergents (syndet).

### BACKGROUND

The state of the art discloses apparatuses, processes, and extrusion screws for processing solid soap in Spitz, L. (2016). Soap Manufacturing Technology. Chapter 8—Bar Soap Finishing. AOCS Press. Published by Elsevier Inc. ISBN 978-1-63067-065-8. DOI https://doi.org/10.1016/C2015-0-00078-8. Spitz (2016) discloses apparatuses (plodders) having barrels, and worms that obtain refined soap pellets, and extruded soap bars. Regarding the worms, Spitz (2016) mentions plodders having a single worm. Said single worms have a constant channel depth, and may have a decreasing pitch. Spitz (2016) also discloses tapered worms that have a decreased diameter near the tip where is located the extrusion die. However, for solid synthetic detergent composition, the worms disclosed by Spitz (2016) need to be operated at high rotation speed to match the production rates needed in the industry, which produces overheating of the extruded synthetic detergent because of shearing stresses. Said overheating leads to reprocessing steps, and additional steps, like cooling the extruded synthetic detergent. Additionally, the conventional worms of soap plodders present surging problems and lack of output stability in the extruded product when said plodders process syndet compositions.

Also, the document Castro, M, et al., (2010). “Comparison of methods to measure yield stress of soft solids. Journal of Rheology”, Volume 54, Issue 1. DOI: https://doi.org/10.1122/1.3248001 discloses that industrial materials are highly viscous or paste-like, i.e., soft solids. Their complexity, proceeding from heterogeneous structures, often reveals interesting rheological properties. Their processing requires the determination of rheological parameters such as viscosity, modulus, and yield stress value. This document mentions that three methods are compared to measure the yield stress of one particular soft solid system, i.e., concentrated surfactant systems, models for bar soap. One method is based on orifice die extrusion and uses the Benbow-Bridgwater equation. Two methods used a rotational rheometer: in one, dynamic (small strain sinusoidal oscillation) experiments were performed as a function of increasing strain amplitude with serrated parallel plate geometry. The maximum in the elastic stress curve was used to estimate the yield stress. The other method using the rotational rheometer, called strand shearing, involves the use of a new fixture designed to grip these samples that were too stiff for serrated plates but too soft for traditional solids fixtures. In this method, the maximum of a plot of stress versus time at a constant shear rate is taken as the yield stress.

The document U.S. Pat. No. 4,510,110 discloses a method for extruding, and/or refining soap, which comprises supplying soap to one end of a helix placed in a casing and rotating the helix to move the soap lengthwise along the casing, and out of the casing. The helix rotates at a speed between 20, and 50 RPM. The length of the helix is 5 to 15 times its diameter. The winding angle of the helix is between 15°, and 25°. The helix has a diameter of about 150 mm, and a helix depth between 30, and 35 mm. Also, the document U.S. Pat. No. 4,510,110 mentions that the helix rotates 20, and 50 RPM. At said rotation speeds, the synthetic detergent would overheat, and would cause the problems previously mentioned.

The document US 2011/0241247 discloses a tapered screw impeller extending at least partly into the extruder cone within the extrude region in a plodder assembly for manufacturing an improved multiphase soap bar product, which enables the use of a broader range of soap materials/formulas, including a broader range of secondary discontinuous phases materials with similar or slightly higher hardness compared to the primary continuous phase hardness, which allows more feasible, easy, and convenient production. This document mentions a stream having primary, and secondary phases, which is extruded using a screw with a tapered section extending into the extruder cone (frustum), and the stream is formed into billets having embedded visually-distinct phases, which billets are subsequently cut, and pressed into bars of soap. The tapered screw is extended sufficiently into the extruder cone to form an “effective” extrusion zone so that the visually-distinct phases, and/or the desirable marbleized patterns are observed in the finished bar.

Accordingly, the state of the art fails to disclose an apparatus, process, and extrusion screw for processing synthetic detergents and/or soaps that overcomes the overheating problems that are generated in the plodders used to process soaps.

### SUMMARY

The present disclosure is related to apparatuses, processes, and extrusion screws directed to process solid detergent compositions in shapes like billets, bars, tablets, noodles, and similar shapes produced from extruded synthetic detergents, soaps, and combinations thereof.

Additionally, the present disclosure is related to improvements or enhancements of a process for the manufacture of syndet (“synthetic detergent”), soap, and combinations thereof in forms as bars, billets, tablets, and noodles, and an extrusion screw for use in the stated process. The invention is related to improvements to the extruder or “plodder”, and to a process that preferably uses an improved single screw for a plodder or an extruder. Syndet comprises materials, such as non-soap surfactants, including synthetic surfactants.

The present disclosure describes an extrusion screw for processing synthetic detergents, soaps, and combinations thereof (e.g., half-synthetic detergent soaps). The extrusion screw comprises a feed section, a metering section, and a compression section located between the feed section, and the metering section. Said compression section has a proximal channel depth adjacent to the feed section, and a distal channel depth adjacent to the metering section. Said the compression section has a compression ratio between 2.2, and 4.1, for example, between 2.2, and 2.6. The extrusion screw may have a length to diameter ratio (L/D) between 4.0, and 6.0. Also, the extrusion screw may have from the feed section to the metering section a variable pitch, and a variable helix angle.

The present disclosure also describes an apparatus for processing synthetic detergents, soaps, and combinations thereof (e.g., half-synthetic detergent soaps). The apparatus comprises a barrel, and an extrusion screw. The barrel has a throat configured to receive raw material that forms soap, and/or syndet compositions, for example, soap, synthetic detergent bases, formulations, additives, oils, lubricants, and combinations thereof. The barrel has an exit configured to deliver the extruded synthetic detergent, soap, or a combination thereof. Said extrusion screw is located inside the barrel and has a feed section adjacent to the throat of the barrel; a metering section having a distal end adjacent to the exit of the barrel, and a compression section located between the feed section, and the metering section. Said compression section has a proximal channel depth (h₂) adjacent to the feed section, and a distal channel depth (h₁) adjacent to the metering section. The compression section has a compression ratio (h₂/h₁) between 2.2, and 4.1, for example, between 2.2 and 2.6.

This extrusion screw allows delivering between 2.0, and 3.0 times more mass output (kg/h) of Syndet at lower screw rotation speed (RPM) in comparison with the screws of conventional plodders used in the industry to extrude soaps. Accordingly, the herein disclosed extrusion screw improves quality consistency of forms of syndet (“synthetic detergent”) and reduces shear heating because of lower screw rotation speed (RPM). This quality consistency is required for the downstream processes like stamping of syndet bars or forming into the desired shape. Additionally, the extrusion screw avoids surging problems and lack of output stability in the extruded product that conventional plodders using conventional screws present when they process syndet compositions.

The present disclosure also describes a process for extruding solid synthetic detergents, soaps, and combinations thereof. The process comprises a step of providing a synthetic detergent formulation, (e.g., a prewarmed synthetic detergent formulation), soap, or a combination thereof (e.g., half synthetic soaps) to an apparatus for processing synthetic detergent in a feed section of an extrusion screw through a throat of a barrel. The process also has a step of compressing said formulation at a temperature between 32° C., and 42° C. with a compression section of the extrusion screw; and a step of conveying the compressed synthetic detergent formulation with a metering section of the extrusion screw towards an exit of the barrel. The rotation speed of the extrusion screw is between 4, and 35 RPM (e.g., between 4 and 20 RPM) depending on extruder diameter or size. Also, the compression section of the extrusion screw has a proximal channel depth (h₂) adjacent to the feed section, and a distal channel depth (h₁) adjacent to the metering section, wherein the compression section has a compression ratio (h₂/h₁) between 2.2, and 4.1, for example, between 2.2 and 2.6.

Said process allows delivering between 2.0, and 3.0 times more mass output (kg/h) of Syndet soap, and combinations thereof at lower screw rotation speed (RPM) in comparison with processes that use conventional plodders used in the industry to extrude soaps. The process allows maintaining syndet, soap, and combinations thereof, at temperatures between 32° C., and 42° C. or between 32° C. and 38° C. Accordingly, the herein disclosed extrusion screw improves quality consistency of forms of syndet, soap, and combinations thereof, and reduces shear heating because of lower screw rotation speed (RPM). This aspect allows stamping the extruded syndet, soap, and combinations thereof, without quenching or waiting steps.

### BRIEF DESCRIPTION OF THE DRAWINGS

FIG. 1 shows an embodiment of an extrusion screw for processing synthetic detergents, soaps, and combinations thereof.

FIG. 2 shows an embodiment of the extrusion screw of FIG. 1 showing its main dimensions.

FIG. 3 shows an embodiment of an apparatus for processing synthetic detergents, soaps, and combinations thereof.

FIG. 4 shows another embodiment of an apparatus for processing synthetic detergents, soaps, and combinations thereof, comprising a preprocessing apparatus, and a lower extruder including said lower extruder an embodiment of the extrusion screw.

FIG. 5 shows a graphic of the Complex Modulus (Pa) vs Oscillation Stress (Pa) at 70° C. of an oscillation stress sweep test for different Synthetic detergent compositions.

FIG. 6 shows a is a graphic of the Phase Angle (°) vs Oscillation Stress (Pa) at 70° C. of an oscillation stress sweep test for different Synthetic detergent compositions.

FIG. 7 shows a graphic of the Complex Modulus (Pa) vs Oscillation Stress (Pa) at 55° C. of an oscillation stress sweep test for different Synthetic detergent compositions.

FIG. 8 shows a is a graphic of the Phase Angle (°) vs Oscillation Stress (Pa) at 55° C. of an oscillation stress sweep test for different Synthetic detergent compositions.

FIG. 9 shows a graphic of the Complex Modulus (Pa) vs Oscillation Stress (Pa) at 40° C. of an oscillation stress sweep test for different Synthetic detergent compositions.

FIG. 10 shows a is a graphic of the Phase Angle (°) vs Oscillation Stress (Pa) at 40° C. of an oscillation stress sweep test for different Synthetic detergent compositions.

FIG. 11 shows the simulation of a extrusion screw (1) to predict the pressure buildup along the axial screw length.

### DETAILED DESCRIPTION

The present disclosure is related to apparatuses, processes, and extrusion screws directed to process synthetic detergent (syndet) compositions, and soap compositions in shapes like billets, bars, tablets, noodles, and similar shapes produced from extruded solid detergents.

In a first aspect of the invention, the present disclosure describes an extrusion screw (1) for processing synthetic detergents, and soaps comprising a feed section (2); a metering section (3); a compression section (4) located between the feed section (1), and the metering section (3). Said compression section (4) having a proximal channel depth (h₂) adjacent to the feed section (2), and a distal channel depth (h₁) adjacent to the metering section (3), and. Said compression section (4) has a compression ratio (h₂/h₁) between 2.2, and 4.1, for example, between 2.2 and 2.6. Referring to FIG. 2, the compression ratio (h₂/h₁) corresponds to the quotient of the proximal channel depth (h₂) over the distal channel depth (h₁).

The extrusion screw (1) may be installed in plodders, and extruders for processing syndet, and soap compositions. In the case of duplex plodders, and plodders having at least to extruders placed in a series arrangement, the extrusion screw (1) may be installed in the lower extruder that produces the finished extruded shape, such as like billets, bars, tablets, noodles, and similar shapes.

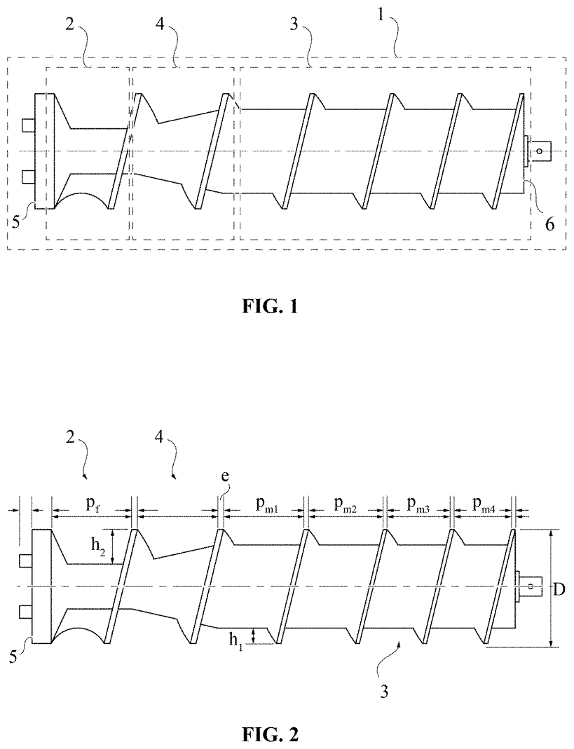

The extrusion screw (1) allows receiving refined pellets in the feed section (2), and compress said pellets in the compression section (4). Referring to FIG. 1, the compression ratio (h₂/h₁) of compression section (4) involves that the channel depth decreases along the extrusion screw (1) axis towards the metering section (3). The compression section (4) allows delivering the soap, syndet of a mixture thereof at higher mass output rates in comparison with an extrusion screw having a constant channel depth, such as the screws used in plodders for soap processing.

Referring to FIG. 1, in a first embodiment of the extrusion screw (1), said extrusion screw (1) may have a length to diameter ratio (L/D) between 4.0, and 6.0. In an example of the extrusion screw (1) it has diameter of D=200 mm and a length to diameter ratio L/D=6.0. In another example of the extrusion screw (1) it has diameter of D=300 mm and L/D=4.0. Other examples of the extrusion screw (1) may have different diameters and length to diameter ratio L/D.

The length to diameter ratio (L/D) range between 4.0, and 6.0 allows producing billets, bars, tablets, noodles, and similar shapes having any air entrapped. Said billets, bars, tablets, noodles, and similar shapes are produced from refined pellets of soap, syndet of a mixture thereof. Said refined pellets may be refined in a preprocessing apparatus (9) that may be selected from mixers, kneaders, and/or extruder apparatuses.

For an extrusion screw (1) directed to produce syndet compositions, the extrusion screw (1) also may have a length to diameter ratio (L/D) between 4.0, and 6.0. One of the advantages of this length to diameter ratio (L/D) is that it allows retrofitting extruders of conventional plodders directed to produce soap, allowing said extruders to increase the mass output rate of extruded shapes as billets, bars, tablets, noodles, and similar shapes, and operate at lower screw rotation speeds. Accordingly, shearing stresses are reduced, and syndet overheating is avoided. Additionally, the extrusion screw (1) avoids surging problems and lack of output stability in the extruded product that conventional plodders using conventional screws present when they process syndet compositions.

Referring to FIG. 2, in various embodiments of the extrusion screw (1), the metering section (3) may have a variable pitch (pₘ₁, pₘ₂ pₘ₃ pₘ₄), and a variable helix angle. The variable pitch allows compressing the syndet, and/or soap to reduce, and preferably eliminate any remaining void. Accordingly, the extruded syndet, and/or soap, or mixture thereof would not have defects such as voids, cracks, and uneven surfaces.

Referring to FIG. 2, the extrusion screw (1) may also have a decreasing flight width to diameter ratio (e/D) between 0.05, and 0.03 for stable conveying of the syndet waxy mass.

As for the feed section (2), this section may have a length to diameter ratio (L_{f}/D) between 0.75, and 1.6 for proper feeding of the syndet waxy mass. This length to diameter ratio (L_{f}/D) may be similar to the length to diameter ratio (L_{f}/D) of conventional screws used in lower extruders of conventional plodders for processing soap. Accordingly, the extrusion screw (1) may be installed in a lower extruder of a soap plodder without modifying or reducing the needed modifications of a hopper (7), barrel (10) and throat (14) of said lower extruder. Optionally, the feed section (2) has a length to diameter ratio (L_{f}/D) between 0.75, and 1.1. This range of the length to diameter ratio (L_{f}/D) allows improvement in material or waxy mass conveying yields.

In the present disclosure, the diameter (D) should be interpreted as the nominal diameter of the extrusion screw (1). Accordingly, the dimensional proportions such as length to diameter ratio (L/D, L_{c}/D, Lₘ/D, L_{f}/D), pitch to diameter ratio (p/D), and flight width to diameter ratio (e/D) are proportions related to said the nominal diameter of the extrusion screw (1).

Additionally, in various embodiments of the extrusion screw (1), including any of the previously mentioned embodiments, the compression section (4) may have a length to diameter ratio (L_{c}/D) between 0.75, and 1.6, for example, between 0.75 and 1.1. Said length to diameter ratio (L_{c}/D) allows the compression section (4) to compress soap, and/or syndet refined pellets to compact them, and avoid defects such as voids or entrapped air-related defects while sharing stresses are kept in a range that does not overheat the soap, and/or syndet. In particular, a compression section (4) having a length to diameter ratio (L_{c}/D) between 0.75 and 1.1 allows a better softening of the material or waxy mass and accounts for a balance between the feed section (2) and metering section (3).

In various embodiments of the extrusion screw (1), including any of the previously mentioned embodiments, the feed section (2), and the compression section (4) may have a pitch to diameter ratio (p/D) between 0.7, and 1.0. One of the advantages of this pitch to diameter ratio (p/D) is that it allows retrofitting extruders of conventional plodders of similar L/D directed to produce soap, allowing said extruders to increase the delivering rate of extruded shapes as billets, bars, tablets, noodles, and similar shapes, and operate at lower screw rotation speeds. Accordingly, the extrusion screw (1) may be installed in a lower extruder of a soap plodder without modifying, or reducing the needed modifications of a shaping die (13) or barrel (10) of said lower extruder.

Similarly, referring to FIG. 2, the pitch (p) of the metering section (3) may have a decreasing pitch to diameter ratio (p/D) between 0.5 and 1.0, for example, between 0.7 and 1.0. This decreasing ratio of said pitch also allows further gradual compression of the waxy mass to improve extrusion conveying and mass output stability. In particular, the pitch to diameter ratio (p/D) between 0.7 and 1.0 allows more work to be applied on the material or waxy mass delivering more homogeneity.

In other embodiments of the extrusion screw (1), said extrusion screw (1) may have different pitches (p), and variable helix angles, length to diameter ratio in the feed section (2), and metering section (3) (Lₘ/D, L_{f}/D), and a different length to diameter ratio (L/D), in case that are used different types of preprocessing apparatuses (9). For example, the length to diameter ratio (L/D) of the extrusion screw (1) may be smaller than 4.0 if the refined pellets have less trapped air, such as the pellets produced by vacuum kneaders or mixers. On the contrary, if the refined pellets have more entrapped air, the length to diameter ratio in the feed section (2), and metering section (3) (Lₘ/D, L_{f}/D) may be increased.

On the other hand, the present disclosure describes an apparatus for processing synthetic detergent or half-synthetic detergent, and soap comprising a barrel (10), and any of the previously described embodiments of the extrusion screw (1).

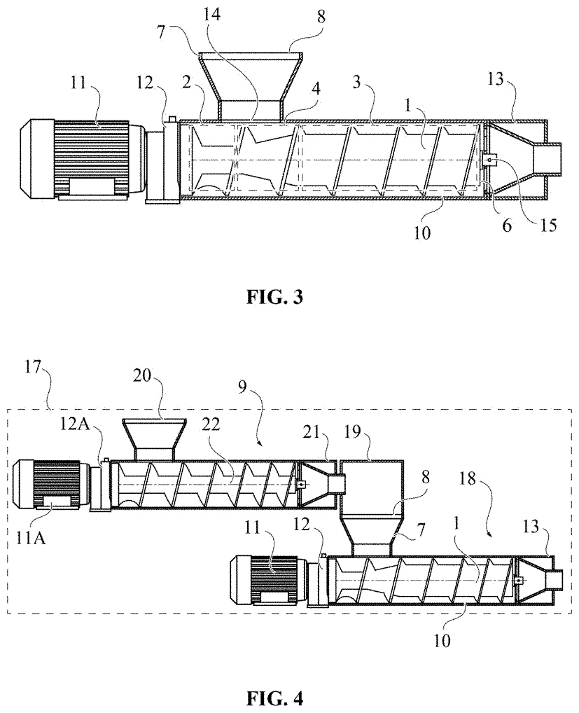

Referring to FIG. 3, the barrel (10) has a throat (14) configured to receive a formulation selected from soap, synthetic detergent, and combinations thereof (e.g., half-synthetic detergent soap), and an exit (15) configured to deliver extruded soap, synthetic detergent, and combinations thereof. Optionally, the formulation is prewarmed at a temperature between 26° C. and 32° C. by a heating apparatus (e.g., a preprocessing apparatus (9)) placed upstream of the barrel (10). An advantage of prewarming the formulation is ensuring a temperature of the formulation inside the barrel (10), and a final temperature when the extruded product exits from the barrel (10) that fits the technical and quality parameters, such as, lack of surface defects like cracks and wrinkles caused by low extrusion temperature (e.g., less than 32° C. or 30° C.) and a temperature related to a quality consistency required for the downstream processes like stamping of syndet bars or forming into the desired shape (e.g., less than 42° C.). For example, full-syndet formulations may generate defects as cracks and wrinkles after being extruded at temperatures lower than 31° C. The defects may appear after 1 hour or more that the extruded billets are stamped. Accordingly, a temperature of 31° C. may allow the billets to be stamped, but, the stamped product would generate defects after few hours.

The extrusion screw (1) is located inside the barrel (10). The feed section (2) may be placed adjacent to the throat (14) of the barrel (10). It should be understood as “adjacent” that the feed section (2) is placed below or next to the throat (14) of the barrel (10). The extrusion screw (1) has a metering section (3) having a distal end adjacent to the exit (15) of the barrel (10), and a compression section (4) located between the feed section (2), and the metering section (3), said compression section (4) having a proximal channel depth (h₂) adjacent to the feed section (2), and a distal channel depth (h₁) adjacent to the metering section (3). The compression section (4) may have a compression ratio (h₂/h₁) between 2.2, and 4.1, for example, between 2.2 and 2.6.

The herein disclosed apparatus allows processing soap, and/or syndet compositions with quality consistency at lower screw rotation speeds, and higher mass output rates in comparison with conventional soap plodders.

Referring to FIG. 4, preferably, the barrel (10) may be a barrel of a lower extruder (18) or a plodder (17) for processing soap. Accordingly, the extrusion screw (1) may have a length to diameter ratio (L/D) between 4.0, and 6. Optionally, the metering section (3) of the extrusion screw (1) has a variable pitch, and a variable helix angle, similar to the variable pitch, and a variable helix angle of conventional screws of said kind of lower extruders (18).

Referring to FIG. 3, in any of the embodiments of the apparatus, said apparatus may include a motor (11) connected to a proximal end (5) of the extrusion screw (1). The motor (11) may be connected to the extrusion screw (1) by a transmission device (12). The motor (11) may also be connected to screw rotation speed control devices, such as frequency variators.

The transmission device (12) may include gears, pulleys, belts, geared belts, chains, sprockets, shafts, transmission shafts, spindles, similar, and equivalent transmission elements known by a skilled artisan, and combinations thereof. In some embodiments of the apparatus, the motor (11), and the transmission device (12) form a geared motor reducer.

The transmission device (12) may be selected between worm gear reducers, gear reducers, cycloidal reducers, planetary reducers, similar, and equivalent transmission devices known by a skilled artisan, and combinations thereof.

The motor (11) may be an electric motor selected from alternating current motors (e.g. three-phase synchronous motors, synchronized asynchronous motors, motors with a permanent magnet rotor, single-phase motors, two-phase motors, wound starter motors, wound starter, and capacitor starter motors), direct current motors (e.g. series excitation motors, parallel excitation motors, compound excitation motors), stepper motors (e.g. with encoder, with motor brake, with heat sinks, with inertial heat sinks, with gear reducers one, two or three-stage planetariums), NEMA 8, NEMA 11, NEMA 17, NEMA 23 or NEMA 34 class stepper motors, equivalent electric motors known to a skilled artisan, and combinations thereof.

In any of the embodiments of the apparatus, said apparatus may include a shaping die (13) located in a distal end of the barrel (10). The shaping die (13) may be any extrusion die suitable to produce shapes such as billets, bars, tablets, noodles, and similar shapes known by a skilled artisan. The shaping die (13) allows shaping the extruded syndet, soap, or combination thereof. The shaping die (13) may include elements such as shearing plates, drilled plates, orifice plates, thermostats, heating devices, cooling devices, cooling channels, cooling/heating jackets, screens, meshes, supports, rotary knives, cones, extension stage cylinders or cones, other tools, and devices used for extrusion dies known by a skilled artisan, and combinations thereof.

Referring to FIG. 4, in any of the embodiments of the apparatus, said apparatus may include a hopper (7) located in the throat (14) of the barrel (10), wherein the hopper (7) has an opening (8) coupled to, or next to a shaping die (16) of a preprocessing apparatus (9). The hopper (7) receives refined pellets from said preprocessing apparatus (9), and feed said refined pellets to the extrusion screw (1) through the throat (14).

The hopper (7) may have a conical shape, and a rest angle configured to allow the refined pellets to flow downwardly.

In one embodiment of the invention, the refined soap, and/or syndet pellets may be provided by a solids supply unit, which can be a hopper (7), a screw conveyor, a screw conveyor with a conical outlet (plug feeder, in English), conveyors of band solids, grizzlies, other conveyors known by a skilled artisan, and combinations thereof.

The preprocessing apparatus (9) may be formed by one or more apparatuses that mix, amalgamate, and/or refines raw material that forms soap, and/or syndet compositions, for example, soap, synthetic detergent bases, formulations, additives, colorants, fillers, conditioning agents, fragrances, oils, lubricants, and other components for soap, and/or syndet compositions/formulations known by a skilled person.

Preferably, the preprocessing apparatus (9) produces refined pellets that are provided to the throat (14) of the barrel (10).

The preprocessing apparatus (9) may be selected between mixers, kneaders, single-screw extruders, twin-screw extruders, vacuum devices, roll mills, simplex refiners, duplex refiners, triplex refiners, amalgamators, heating apparatuses, and equivalent preprocessing apparatuses known by a skilled artisan, and combinations thereof. The preprocessing apparatus (9) may have two or more refining stages. Each refining stage is a mixer or refiner connected in series to one or more mixers, and refiners.

The preprocessing apparatus (9) allows producing homogeneous pellets, improving bar feel by eliminating low solubility hard particles, and enhancing product lather, solubility, and firmness. Also, the preprocessing apparatus (9) may be configured to prewarm the formulation to be extruded to avoid generation of defects in the extruded product.

The preprocessing apparatus (9) may include a hopper (20) similar to the hopper (7). The hopper (20) receives raw material that forms soap, and/or syndet compositions, or partially processed materials soap, and/or syndet compositions. The preprocessing apparatus (9) may also include a solids supply unit, which can be a hopper (20), a screw conveyor, a screw conveyor with a conical outlet (plug feeder, in English), conveyors of band solids, grizzlies, other conveyors known by a skilled artisan, and combinations thereof.

The preprocessing apparatus (9) may also include one or more mixing elements selected from screws, worms (22) (e.g., tangential twin worms, non-tangential twin worms, high volume worms, high-efficiency worms, constant root diameter worms, worms having a decreasing pitch, worms having a constant pitch, double-spiral high-shear type worms) rolls, crimping blades, mixing blades, sigma blades, similar, and equivalent mixing elements known by a skilled artisan, and combinations thereof.

The preprocessing apparatus (9) may also include one or more motors (11A), and transmission devices (12A) such as the motor (11), and transmission device (12) that may be connected to the extrusion screw (1). Said one or more motors (11A), and transmission devices (12A) are connected to the mixing elements.

The preprocessing apparatus (9) may include a pelletizing die (21) located in the distal of said preprocessing apparatus (9). The pelletizing die (21) shapes, and cuts the refined pellets produced by the preprocessing apparatus (9). The pelletizing die (21) may be adjacent to the opening (8) of the hopper (7).

In any of the embodiments of the apparatus, the pelletizing die (21) may be any extrusion die suitable to produce pellets known by a skilled artisan. The pelletizing die (21) allows shaping the refined pellets of syndet, soap, or combination thereof. The pelletizing die (21) may include elements such as shearing plates, drilled plates, orifice plates, thermostats, heating devices or apparatuses, cooling devices or apparatuses, cooling channels, cooling/heating jackets, screens, meshes, supports, rotary knives, cones, extension stage cylinders or cones, other tools, and devices used for extrusion dies known by a skilled artisan and combinations thereof.

In some embodiments of the apparatus, the preprocessing apparatus (9) may be connected to the hopper (7) by a vacuum chamber (19). In this case, the preprocessing apparatus (9), and the barrel (10) operate in vacuum conditions. This allows reducing the air contained in the barrel (10), and permits producing less air-related defects in the extruded soap, and/or syndet.

Referring to FIG. 4, in an embodiment of the apparatus, said apparatus may be a plodder (17) having an upper extruder, and a lower extruder (18). The lower extruder (18) comprises the barrel (10), shaping die (13), and the extrusion screw (1). The upper extruder is the preprocessing apparatus (9).

The herein disclosed apparatus may also include a cutter located adjacent to the exit (15). In the embodiments of the apparatus having a shaping die (13), the cutter is located next to said shaping die (13). The cutter receives the extruded soap, and/or syndet composition that may get out from the barrel (10) in billets. The cutter allows producing single slugs of a predetermined length that may be a length needed to fit in a stamping apparatus.

Said cutter can cut single length, long multilength, and short length for recycling mode slugs. The application of engraving rollers may be used as an alternative to stamping. Engraving can be on two horizontal, two vertical, or all four sides of the slug.

The herein disclosed apparatus may also include a press or stamping apparatus configured to receive extruded soap, and/or syndet slugs, and produce soap, and/or syndet bars. Preferably, the press or stamping apparatus is a flash stamping type soap apparatus.

One of the advantages of any of the herein disclosed embodiments of the apparatus is that the extrusion screw (1) allows delivering a higher volume of extruded soap, and/or syndet billets per minute at lower screw rotation speed than a conventional lower extruder of a soap plodder. This lower screw rotation speed processing allows maintaining the extruded soap, and/or syndet billets at lower temperatures than the usually reached in a conventional lower extruder of a soap plodder. Said conventional lower extruder of a soap plodder overheat the extruded soap, and/or syndet billets because of the high screw rotation speed needed to reach the extrusion volumes required in the industrial processes, and impedes a correct stamping. This generates an obstacle in the production lines.

The present disclosure also describes a process for extruding soaps, syndet compositions, and combinations thereof such as solid synthetic detergents or half-synthetic soaps. Preferably, the process is executed by any of the previously explained embodiments of the apparatus.

The process includes the following steps:
providing a formulation (for example, a prewarmed formulation) selected from soap, syndet compositions, and combinations thereof (e.g., half-synthetic soap) to an apparatus for processing soap, syndet compositions, and combinations thereof in a feed section (2) of an extrusion screw (1) through a throat (14) of a barrel (10);
conveying the compressed formulation with a metering section (3) of the extrusion screw (1) towards an exit (15) of the barrel (10),
wherein the screw rotation speed of the extrusion screw (1) is between 4, and 35 RPM or between 4 and 20 RPM, depending on screw diameter or size, since at larger screw diameter, extruders operate at lower screw rotation speeds (RPM) to maintain a controlled mass temperature and homogeneity, and
wherein the compression section (4) of the extrusion screw (1) has a proximal channel depth (h₂) adjacent to the feed section (2), and a distal channel depth (h₁) adjacent to the metering section (3), wherein the compression section (4) has a compression ratio (h₂/h₁) between 2.2, and 4.1 or between 2.2 and 2.6.

In the step of providing a formulation, said formulation is delivered in a feed section (2) of an extrusion screw (1) through a throat (14) of a barrel (10). The step of providing the formulation to the barrel (10) may be executed by a hopper (7). This step may be also executed by a mass or solids supply unit. Said formulation preferably is provided in a noodle or pellet shape.

The formulation noodles or pellets may be formed and/or prewarmed (e.g., at a temperature between 26° C. and 32° C.) by any of the previously explained embodiments of the preprocessing apparatus (9). Accordingly, the process may include a step previous to providing the formulation to the barrel (10). Said previous step may be receiving raw materials that form soap, and/or syndet compositions, for example, soap, synthetic detergent bases, formulations, additives, colorants, fillers, conditioning agents, fragrances, oils, lubricants, and other components for soap, and/or syndet compositions/formulations known by a skilled person. The preprocessing apparatus (9) may also receive recycled soap, and/or syndet in pellets, flakes, or other similar shapes.

In an embodiment of the process, the formulation may include a synthetic detergent base, a fragrance, a conditioning agent, coconut oil, a natural extract, a colorant, and a filler.

In any of the embodiments of the process, said process may include a preprocessing step selected from mixing, refining, amalgamating, or a combination thereof. The preprocessing step may be executed by a mixer or kneader of the preprocessing apparatus (9). At the end of the preprocessing step is obtained the formulation provided to the barrel (10).

In any of the embodiments of the process, the step of compressing the formulation at a temperature between 32° C., and 42° C. or between 32° C. and 38° C. with a compression section (4) of the extrusion screw (1) allows stabilizing the rheological characteristics of the formulation. This temperature range is maintained while the screw rotation speed of the extrusion screw (1) is between 4, and 35 RPM or between 4 and 20 RPM depending on screw diameter or size, since at larger screw diameter, extruders operate at lower screw rotation speeds (RPM) to maintain a controlled mass temperature and homogeneity. In particular, compressing the formulation at a temperature between 32° C., and 42° C. allows avoiding defects in the extruded soap, and/or syndet billets (e.g., stretch marks, cracks, uneven surface) that are generated with temperatures lower that 32° C., in particular, when are being processed syndet and half-syndet compositions. Similarly, temperatures of more the 42° C. may cause that the extruded soap, and/or syndet billets exit from the extruder at temperatures that are not suitable for stamping and shaping processes. The temperature between 32° C., and 42° C. may be reached with help of the prewarmed formulation previously preheated by the preprocessing apparatus (9) at temperature between 32° C., and 42° C.

The compression ratio (h₂/h₁) between 2.2, and 4.1 or between 2.2 and 2.6 allows reaching delivery rates of extruded soap, and/or syndet billets of more than 300 kg/h at the screw rotation speeds between 4 and 35 RPM depending on screw diameter or size. This screw rotation speed avoids producing shearing stresses that induce heat in the formulation. This topic is important in formulations comprising syndet, because when the formulation overheats its rheology changes. If the extruded soap, and/or syndet overheats, it impedes a proper consistency and a correct stamping. The conventional plodders need to use high screw rotation speeds to reach the extruded soap, and/or syndet production rates needed for flash stamping steps. Said high screw rotation speeds induce the said overheating problem.

Accordingly, the process may be executed with the extrusion screw (1) operating at a screw rotation speed between 4, and 35 RPM, 4, and 30 RPM, 4, and 25 RPM, 4, and 20 RPM, between 4, and 18 RPM, between 4, and 15 RPM, between 4, and 5 RPM, between 4, and 4.5 RPM, between 4, and 4.4 RPM, between 4, and 6 RPM, between 4, and 9 RPM, between 4.2, and 4.4 RPM, between 4.2, and 4.8 RPM, between 4, and 5.5 RPM or in other screw rotation speed range between 4, and 20 RPM.

The screw rotation speed range may be selected according to the soap, and/or syndet composition. For composition comprising more than 50% of syndet bases, the screw rotation speed may be between 4 RPM and 6 RPM. However, the screw rotation speed may be controlled with a computing unit connected to the motor (11) coupled to the extrusion screw (1). The computing unit may receive temperature data from a sensor device configured to measure the temperature of the extruded soap, and/or syndet composition. The computing unit may execute a control process that obtains a control signal that may be sent to a frequency variator or other type of screw rotation speed control device coupled to the motor (11) or contained in the motor (11). The control process may include proportional derivative control, proportional-integrative-derivative control, on/off control, and other control steps, methods, and processes known by a person skilled in the art.

Also, the screw rotation speed, may be selected according to the dimensions of the extrusion screw (1) (e.g., diameter and/or size). For example, the screw rotation speed may be determined from a screw rotation speed of a known first extrusion screw (1′), according to the expression:

$$Screw rotation speed ( N ) [ RPM ] \text{:} = {{N}_{1} ( \frac{D 2}{D 1} )}^{{2}_{Ψ} - 2}$$

### Wherein

N₁ is the Screw rotation speed of a known first extrusion screw (1′);
D₁ is the Screw nominal diameter of a known first extrusion screw (1′);
D₂ is the Screw nominal diameter of the extrusion screw (1) to be determined its Screw rotation speed, and
ψ is a parameter obtained from the rheology of the composition to be processed with the extrusion screw (1).

Similarly, other variables of the extrusion screw (1) (physical and process variables) may be obtained from known variables of the known first extrusion screw (1′). Examples of these variables are the following:

$$Mass output ( Mp ) [ kg \text{/} h ] \text{:} = M {{p}_{1} ( \frac{D 2}{D 1} )}^{{3}_{Ψ}} , and$$

$$Channel depth ( h ) [ mm ] = h 1 {( \frac{D 2}{D 1} )}^{Ψ}$$

### Wherein

D₁ is the Screw nominal diameter of a known first extrusion screw (1′);
D₂ is the Screw nominal diameter of a the extrusion screw (1) to be determined, and
h₁ is the Channel depth of the known first extrusion screw (1′);
Mp₁ is the Mass output of the known first extrusion screw (1′), and
ψ is a parameter obtained from the rheology of the composition to be processed with the extrusion screw (1).

These equations to obtain values of variables of the extrusion screw (1) (physical and process variables) may be based on models retrieved from the articles Potente, Helmut, P. Fischer, (1977). Modellgesetze für die Auslegung von Plastifiziereinschneckenextrudern, Kunststoffe 67, 242-247 and Potente, Helmut, (1981). Auslegen von Schneckenmaschinen-Baureihen—Modellgesetze und ihre Anwendung, Carl Hanser Verlag that are herein fully-incorporated by reference.

The herein disclosed process may include a step of shaping the compressed formulation with a shaping die (13). This shaping step allows for producing billets or similar forms. The shaping die (13) may be any of the shaping die (13) of the apparatus previously explained.

The herein disclosed process may include a step of cutting the billets of the shaping step into bars of a predetermined length. Said predetermined length may be a nominal length of a press or flash stamping apparatus

### EXAMPLE 1

### Extrusion Screw for Processing Syndet

It was designed, and produced an extrusion screw (1) having the following characteristics:
Nominal Diameter (D): 297 mm
Nominal Length (L): 1212 mm
Length over Diameter ratio (L/D): 4.6
Feed section (2) length over extrusion screw (1) length ratio (L_{f}/D): 0.17
Distal channel depth (h₁): 40 mm
Proximal channel depth (h₂): 90 mm
Compression ratio (h₂/h₁): 2.25
Compression section (4) length to diameter ratio (L_{c}/D): 0.70
Metering section (3) length to diameter ratio (Lₘ/D): 2.6
Pitch to diameter ratio (p_{f-c}/D) in the feed section (2), and the compression section (3): 0.75
Variable pitch in the metering section (3): 0.5
Variable helix angle in the metering section (3): 9.0

### EXAMPLE 1.1

### Extrusion Screw for Processing Syndet

It was designed, and produced an extrusion screw (1) having the following characteristics:
Nominal Diameter (D): 298 mm
Nominal Length (L): 1212 mm
Length over Diameter ratio (L_{f}/D): 4.0
Feed section (2) length to diameter ratio (L_{f}/D): 0.75
Distal channel depth (h₁): 40 mm
Proximal channel depth (h₂): 90 mm
Compression ratio (h₂/h₁): 2.25
Compression section (4) length to diameter ratio (L_{c}/D): 0.75
Metering section (3) length to diameter ratio (Lₘ/D): 2.5
Pitch to diameter ratio (p_{f-c}/D) in the feed section (2): 0.70
Helix angle in the feed section (2): 12.6
Pitch to diameter ratio in the compression section (3): 0.65
Helix angle in the compression section (3): 11.7
Variable pitch in the metering section (3): 0.55 to 0.5
Variable helix angle in the metering section (3): 9.9 to 9.0

### EXAMPLE 2

### Extrusion Test of the Extrusion Screw (1) of Example 1

It was tested the extrusion screw (1) of example 1 in a Binacchi VAC plodder, in its lower screw section to produce syndet billets having an average weight of 215 g. The extruded syndet composition is Syndopal 300® that includes Sodium Cocoyl Isethionate, Hydrogenated Vegetable Oil, Aqua, Polyglyceryl-4 Laurate, Glycerin, and Tetrasodium Glutamate Diacetate.

The following Table 1 list the test results:

TABLE 1
Testing results for extrusion screw (1) of example 1

| Screw rotation | Billets per | Grams per | | |
|---|---|---|---|---|
| speed (RPM) | minute | minute | Kg/h | Comments |
| 4.40 | 25 | 5375 | 322.5 | Quantity of billets |
| | | | | suitable for stamper |
| 4.40 | 24 | 5160 | 309.6 | Quantity of billets |
| | | | | suitable for stamper |
| 4.40 | 25 | 5375 | 322.5 | Quantity of billets |
| | | | | suitable for stamper |
| 4.40 | 25 | 5375 | 322.5 | Quantity of billets |
| | | | | suitable for stamper |
| 4.40 | 25 | 5375 | 322.5 | Quantity of billets |
| | | | | suitable for stamper |
| 4.40 | 25 | 5375 | 322.5 | Quantity of billets |
| | | | | suitable for stamper |
| 4.40 | 25 | 5375 | 322.5 | Quantity of billets |
| | | | | suitable for stamper |
| 4.20 | 24 | 5160 | 309.6 | Quantity of billets |
| | | | | suitable for stamper |
| 4.20 | 24 | 5160 | 309.6 | Quantity of billets |
| | | | | suitable for stamper |
| 4.20 | 24 | 5160 | 309.6 | Quantity of billets |
| | | | | suitable for stamper |

The measured billet temperatures with the extrusion screw (1) for the different operating conditions were in a range between 31.3° C. and 35.3° C. that were suitable for stamper. The same plodder having a conventional screw of the same diameter as the extrusion screw (1) of this example was used to extrude Syndopal 300®. The mass output rate of the plodder having a conventional screw was 18 billets per minute, and the screw rotation speed was between 10.10 RPM, and 10.40 RPM. Accordingly, plodder having the extrusion screw (1) of example 1 obtained 2.4 times more mass output of extruded syndet at lower RPM. It is possible with the extrusion screw (1) to obtain even more mass output rates, but the stamping process was the bottleneck in this case.

### EXAMPLE 3

### Oscillation Stress Sweep Test for Different Synthetic Detergent Compositions

The oscillation stress sweep test provides a simple quantification of the rigidity, and strength of soft solid structures present throughout a sample. The test entails the application of small, incrementing sinusoidal (i.e., clockwise then counter-clockwise) the shear stresses to the sample whilst monitoring its resulting deformation, and/or flow. In the early stages of the test, the stress is sufficiently low to preserve the structure. The presence of this structure is revealed by dominant elastic deformation (rather than viscous flow) signified by a phase angle plateau at low values.

The phase angle is a measure of the relative dominance of elastic or viscous response of the sample and ranges from 0° for an ideal elastic material (i.e., a perfect solid) to 90° for an ideal viscous material (a perfect liquid). At this stage the sample rigidity, the complex modulus, also remains at a plateau value. As the test progresses the incrementing applied stress eventually disrupts sample structure as the yielding process progresses. This is manifested as a loss of elastic response (phase angle rises), and an accompanying decrease in rigidity (complex modulus decreases).

The oscillation stress sweep may also be presented as storage modulus (G′), and loss modulus (G″) as a function of applied stress. Storage, and loss modulus are measures of the respective abilities for the material to store energy through elastic deformation or dissipate energy through viscous flow during each oscillatory deformation cycle.

Accordingly, the following samples were tested:
Soapworks Pure
Soapworks Mix
Soapworks Extruded
Alternate Pure
Alternate Mix
Alternate Extruded

“Soapworks Pure”, and “Alternate Pure” are synthetic detergent bases. “Soapworks Mix”, and “Alternate Mix” have the following physical mixed composition without extrusion process:
Synthetic detergent base: 95.14%
Fragrance: 2%
Conditioning agent: 1%
Coconut Oil: 0.25%
Natural extract: 0.6%
Colourant: 0.0065%
Filler: 1%

“Soapworks extruded”, and “Alternate extruded” have the above composition with the extrusion process.

Testing was performed on a research rheometer (DHR2, TA Instruments) fitted with a 20 mm crosshatched plate measuring system, testing gap set to 1000 μm. A solvent trap cover was employed for all rheological analyses to minimize the atmospheric exposure of the samples at the geometry edge. Testing was attempted at 40° C., 55° C., and 70° C. Following a 60 s equilibration time at the desired temperature, the samples were exposed to an oscillatory stress sweep ranging from 0.1 Pa to 10,000 Pa, 1 Hz oscillation frequency. A step termination was set such that if at any point the oscillation strain exceeded 3000% the test would immediately end.

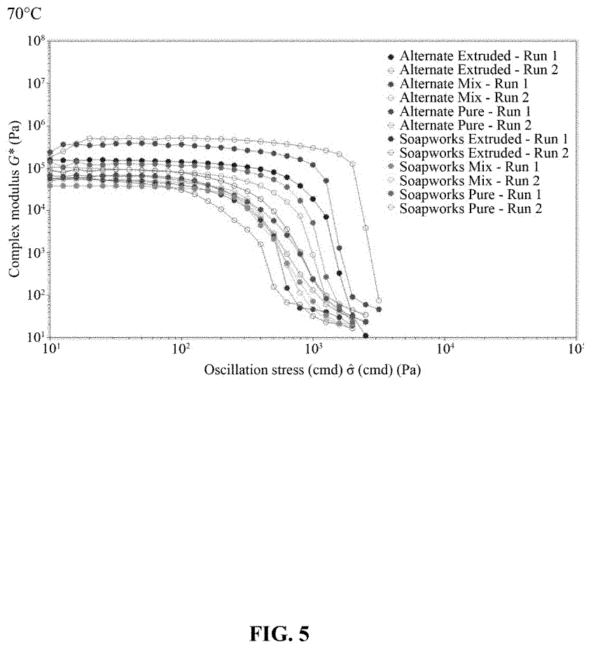

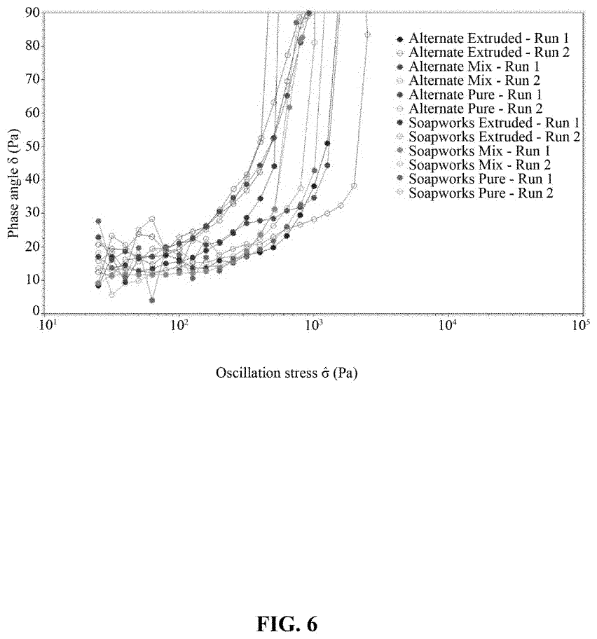

Referring to FIG. 5, this figure is a graphic of the Complex Modulus (Pa) vs Oscillation Stress (Pa) at 70° C. FIG. 6 shows a is a graphic of the Phase Angle (°) vs Oscillation Stress (Pa). The following table 2 shows the yield stress results for 70° C.

TABLE 2
Yield Stress Data at 70° C.
Yield stress (Pa)

| | | Run 1 | Run 2 | Mean |
|---|---|---|---|---|
| Alternate | Extruded | 569 | 445 | 507 |
| | Mix | 300 | 275 | 288 |
| | Pure | 692 | 952 | 822 |
| Soapworks | Extruded | 225 | 152 | 189 |
| | Mix | 295 | 324 | 310 |
| | Pure | 627 | 392 | 510 |

All yield stress data were quantified using an onset model fit to the complex modulus data. This entailed fitting one straight line through the low-stress plateau, and a second through the inflection point as the sample yields. The stress at which these two lines cross was taken as the yield stress.

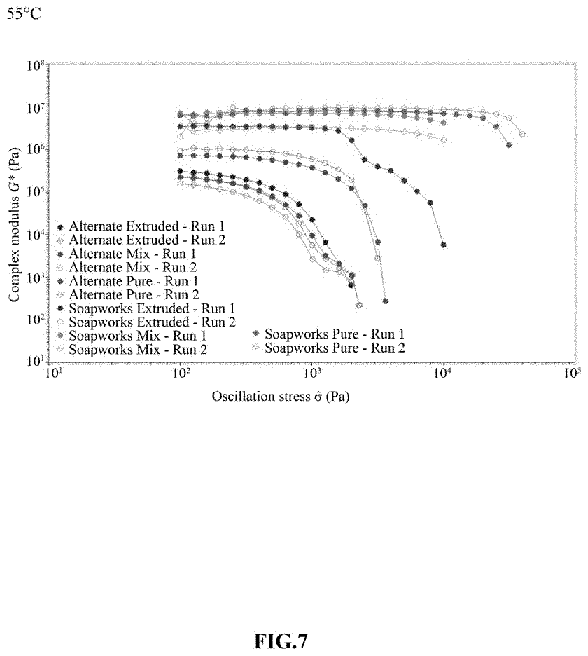

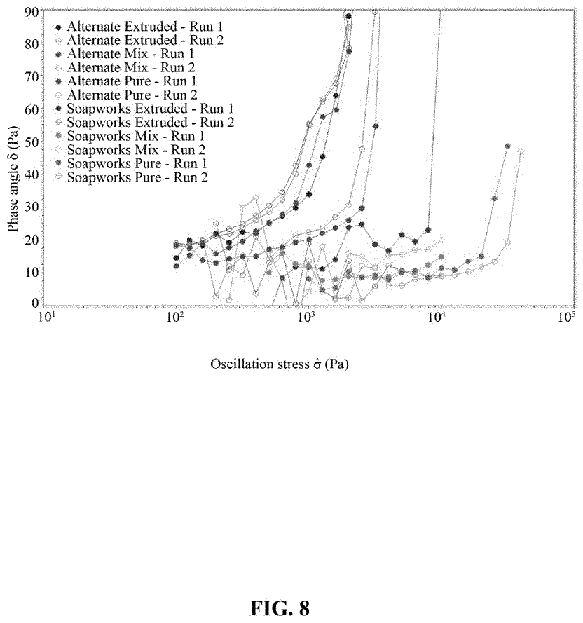

Now referring to FIG. 7, this figure is a graphic of the Complex Modulus (Pa) vs Oscillation Stress (Pa) at 55° C. FIG. 8 shows a is a graphic of the Phase Angle (°) vs Oscillation Stress (Pa). The following table 3 shows the yield stress results for 55° C.

TABLE 3
Yield Stress Data at 55° C.
Yield stress (Pa)

| | | Run 1 | Run 2 | Mean |
|---|---|---|---|---|
| Alternate | Extruded | 678 | 514 | 596 |
| | Mix | 552 | 454 | 503 |
| | Pure | 1830 | 1270 | 1550 |
| Soapworks | Extruded | — | — | — |
| | Mix | — | — | — |
| | Pure | — | — | — |

The samples marked “Soapworks” did not consistently yield over the range of stress applied, the extruded sample did appear to yield in the first repeat but it is thought that this was due to fracture of the sample.

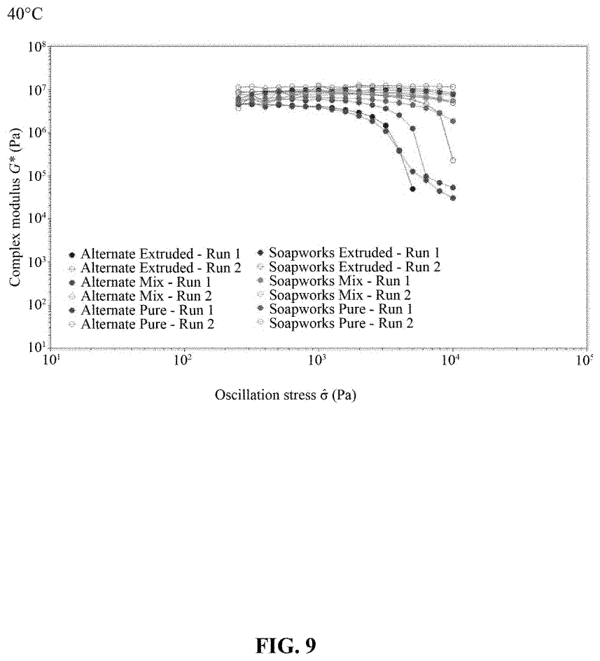

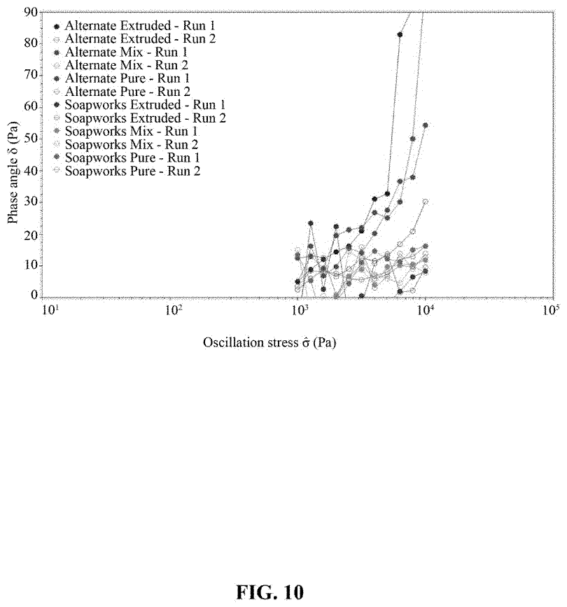

Now referring to FIG. 9, this figure is a graphic of the Complex Modulus (Pa) vs Oscillation Stress (Pa) at 40° C. FIG. 10 shows a is a graphic of the Phase Angle (°) vs Oscillation Stress (Pa). The following table 4 shows the yield stress results for 40° C.

TABLE 4
Yield Stress Data at 40° C.
Yield stress (Pa)

| | | Run 1 | Run 2 | Mean |
|---|---|---|---|---|
| Alternate | Extruded | 2590 | 4990 | 3790 |
| | Mix | — | — | — |
| | Pure | 4440 | / | 4440 |
| Soapworks | Extruded | — | — | — |
| | Mix | — | — | — |
| | Pure | 3740 | — | 3740 |

None of the samples consistently yield over the range of stress applied at 40° C., the “alternative” samples did appear to yield in the first repeat but it is thought that this was due to fracture of the sample.

The samples all noticeably soften when performing the testing at 70° C., at this elevated temperature the samples repeatedly show a well-defined structure that yields once certainly applied stress is exceeded. The “Soapworks” samples generally show higher yield stresses than the “Alternate” samples.

At 55° C., Soapworks samples proved particularly difficult to generate yield stress data. The sample was simply too stiff for the technique to be applicable. When testing was attempted at 40° C. this was true of both sample sets.

The test demonstrates how temperature changes drastically modify the rheology of the syndet compositions, accordingly, it is important to maintain, and control the temperature in the extrusion process.

### EXAMPLE 4

### Scaling Relations for the Extrusion Screw (1)

The extrusion screw (1) was scaled to the following proportions:
Extrusion screw (1) length to diameter ration: 4.0<L/D<6.0
Compression ratio (BETA): 2.2<BETA<2.6
Variable pitch from the metering to the feed section (3): 0.5<p/D<0.7
Variable helix angle from the metering to the feed section (3): 9.0<Phi<12.5

Accordingly, depending on the nominal diameter (D) of the extrusion screw (1) can be scaled the other dimensions for several embodiments of the extrusion screw (1).

### EXAMPLE 4.1

### Scaling Relations for the Extrusion Screw (1)

The extrusion screw (1) was scaled to the following proportions:
Extrusion screw (1) length to diameter ration: 4.0<L/D<6.0
Compression ratio (BETA): 2.2<BETA<4.1
Variable pitch from the metering to the feed section (3): 0.5<p/D<0.7
Variable helix angle from the metering to the feed section (3): 9.0<Phi<12.6

Accordingly, depending on the nominal diameter (D) of the extrusion screw (1) can be scaled the other dimensions for several embodiments of the extrusion screw (1).

### EXAMPLE 5

### Plodder Comprising an Extrusion Apparatus

It was retrofitted a plodder having an upper preprocessing apparatus (9), and a lower extruder. The lower extruder is an extrusion apparatus having a barrel (10), and the extrusion screw (1) of example 1. The preprocessing apparatus (9) is a twin-screw extruder that mixes, and refines unrefined syndet, and/or soap pellets.

### EXAMPLE 6

### Plodder Comprising an Extrusion Apparatus, and a Kneader

The plodder of example 5 was modified to process a mixture of soap, and syndet. The preprocessing apparatus (9) was in this example a kneader.

### EXAMPLE 7

### Extrusion Simulation of the Extrusion Screw (1) of Examples 1 and 2

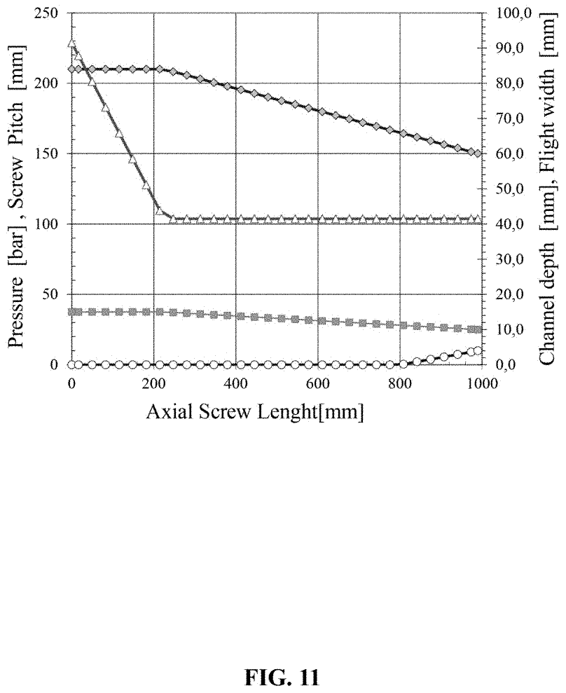

It was designed, and simulated a modified extrusion screw (1) of examples 1 and 2, having a decreasing variable pitch (p) (e.g., pₘ₁, pₘ₂ pₘ₃ pₘ₄) from the feed section (2) to the metering section (3), variable channel depth (h) as a short compression and variable flight width (e) from the feed section (2) to the metering section (3), with the characteristics showed in FIG. 11.

FIG. 11 shows the simulation of extrusion screw (1) to predict the pressure buildup along the axial screw length as a function of the extrusion screw (1) geometry: screw pitch (p), channel depth (h) and flight width (e).

The black line with circles in FIG. 11 is the pressure, the blue line with the rhomboids is the screw pitch (p), the red line with triangles is the channel depth (h) and the green line with squares is the flight width (e). The short compression of extrusion screw (1) and the obtained pressure buildup in the metering section (3) are accounting for constant extrusion conveying, mass output stability, and suitable billet temperature for stamp forming.

### EXAMPLE 8

### Dimensioning of the Extruder Series from Reference Extrusion Screw (1) Based on Scale-Up Simulations

The extrusion screw (1) of example 1.1 is considered the model extruder or reference extruder to be scaled-up to different extrusion screw (1) diameters (D) [mm] and operating conditions, such as, screw rotation speed (N) [RPM] and mass output (Mp) [kg/h] that allow extruding syndet and soap formulations that are suitable for stamping after extrusion. The inputs are the 298 mm manufactured and tested screw geometry with its operating conditions, and the outputs are the scaled-up screw geometries, with their operating conditions.

Accordingly, the simulation was based on a scaling-up of a manufactured 298 mm known extrusion screw (1′) having a screw diameter (D1) to other screw diameters (D2) (i.e., 45, 60, 90, 120, 150 and 200 mm) maintaining a constant length. The aim was to design the extruder series with their scaled-up screw geometries and operating conditions, for a feasible and reproducible process at different extruder sizes. Minor process changes are possible based on operating conditions. The applied scale-up equations are shown below.

$$Screw rotation speed ( N ) [ RPM ] \text{:} = {{N}_{1} ( \frac{D 2}{D 1} )}^{{2}_{Ψ} - 2}$$

$$Mass output ( Mp ) [ kg \text{/} h ] \text{:} = M {{p}_{1} ( \frac{D 2}{D 1} )}^{{3}_{Ψ}} , and$$

$$Channel depth ( h ) [ mm ] = {h }_{1} {( \frac{D 2}{D 1} )}^{Ψ}$$

### Wherein

N₁ is the Screw rotation speed of the known extrusion screw (1′);
D₁ is the Screw nominal diameter of a known extrusion screw (1′);
D₂ is the Screw nominal diameter of the extrusion screw (1) to be determined;
h₁ is the Channel depth of the known extrusion screw (1′);
Mp₁ is the Mass output of the known extrusion screw (1′), and
ψ is a parameter obtained from the rheology of the composition (waxy mass) to be processed with the extrusion screw (1).

The results of the simulation are recorded in the following table:

| 45 | 60 | 90 | 120 | 150 | 200 | 298 | D |
|---|---|---|---|---|---|---|---|
| 13.7 | 11.5 | 9.0 | 7.6 | 6.6 | 5.6 | 4.4 | RPM |
| 6.1 | 11.1 | 26.1 | 47.7 | 76.3 | 139.6 | 322.5 | kg/h |
| 24.0 | 29.3 | 38.9 | 47.6 | 55.7 | 68.1 | 90.0 | h2 |
| 10.7 | 13.0 | 17.3 | 21.2 | 24.7 | 30.3 | 40.0 | h1 |
| 2.25 | 2.25 | 2.25 | 2.25 | 2.25 | 2.25 | 2.25 | BETA |

It should be understood that the invention described in the present disclosure is not limited to the embodiments described, and illustrated, as it will be evident to a person skilled in the art that there are variations, and possible modifications that do not depart from the spirit of the invention, which only it's defined by the following claims.

What is claimed is:

1. An extrusion screw (1) for processing synthetic detergents, soaps, and combinations thereof, comprising:
a feed section (2);
a metering section (3);
a compression section (4) located between the feed section (1), and the metering section (3), said compression section (4) having a proximal channel depth (h₂) adjacent to the feed section (2), and a distal channel depth (h₁) adjacent to the metering section (3), and
wherein the compression section (4) has a compression ratio (h₂/h₁) between 2.2, and 2.6.

2. The extrusion screw (1) of claim 1, wherein the compression section (4) has a compression ratio (h₂/h₁) between 2.2, and 4.1.

3. The extrusion screw (1) of claim 1, wherein the metering section (3) has a variable pitch, and a variable helix angle.

4. The extrusion screw (1) of claim 1, wherein the extrusion screw (1) has a length to diameter ratio (L/D) between 4.0, and 6.

5. The extrusion screw (1) of claim 1, wherein the feed section (2) has a length to diameter ratio (L_{f}/D) between 0.75, and 1.6

6. The extrusion screw (1) of claim 1, wherein the compression section (4) has a length to diameter ratio (L_{c}/D) between 0.75, and 1.6

7. The extrusion screw (1) of claim 1, wherein the feed section (2), and the compression section (4) have a pitch to diameter ratio (p/D) between 0.7, and 1.0.

8. The extrusion screw (1) of claim 1, wherein the pitch of the metering section (3) has a decreasing rate of pitch to diameter ratio (p/D) between 0.5 and 1.0 and/or has a decreasing flight width to diameter ratio (e/D) between 0.05, and 0.03.

9. An apparatus for processing for processing synthetic detergents, soaps, and combinations thereof, and comprising:
a barrel (10) having a throat (14) configured to receive a formulation selected from soap, synthetic detergent, and combinations thereof, and an exit (15) configured to deliver extruded soap, synthetic detergent, and combinations thereof, and
an extrusion screw (1) located inside the barrel (10), and having:
a feed section (2) adjacent to the throat (14) of the barrel (10);
a metering section (3) having a distal end adjacent to the exit (15) of the barrel (10);
a compression section (4) located between the feed section (2), and the metering section (3), said compression section (4) having a proximal channel depth (h₂) adjacent to the feed section (2), and a distal channel depth (h₁) adjacent to the metering section (3), and
wherein the compression section (4) has a compression ratio (h₂/h₁) between 2.2, and 2.6.

10. The apparatus of claim 9, wherein the compression section (4) has a compression ratio (h₂/h₁) between 2.2, and 4.1.

11. The apparatus of claim 9, wherein the metering section (3) of the extrusion screw (1) has a variable pitch (p), and a variable helix angle.

12. The apparatus of claim 9, wherein the extrusion screw (1) has a length to diameter ratio (L/D) between 4.0, and 6.0.

13. The apparatus of claim 9, further comprising a motor (11) connected to a proximal end (5) of the extrusion screw (1).

14. The apparatus of claim 13, further comprising a transmission device (12) connected between the motor (11), and the extrusion screw (1).

15. The apparatus of claim 9, further comprising a shaping die (13) located in a distal end of the barrel (10).

16. A process for extruding soap, synthetic detergent, and combinations thereof, and comprising the steps:
providing a formulation selected from soap, synthetic detergent, and combinations thereof to an apparatus for processing soap, synthetic detergent, and combinations thereof in a feed section (2) of an extrusion screw (1) through a throat (14) of a barrel (10);
compressing the formulation at a temperature between 31° C., and 38° C. with a compression section (4) of the extrusion screw (1);
conveying the compressed formulation with a metering section (3) of the extrusion screw (1) towards an exit (15) of the barrel (10),
wherein the screw rotation speed of the extrusion screw (1) is between 4, and 20 RPM, and
wherein the compression section (4) of the extrusion screw (1) has a proximal channel depth (h₂) adjacent to the feed section (2), and a distal channel depth (h₁) adjacent to the metering section (3), wherein the compression section (4) has a compression ratio (h₂/h₁) between 2.2, and 2.6.

17. The process of claim 16, wherein the temperature in the compression step is between 32° C. and 42° C., and wherein the compression section (4) has a compression ratio (h₂/h₁) between 2.2, and 4.1.

18. The process of claim 16, further comprising a step of shaping the compressed formulation with a shaping die (13).

19. The process of claim 16 wherein the screw rotation speed of the extrusion screw (1) is selected between 4, and 35 RPM, wherein screw rotation speed is determined taking as input at least one parameter selected from screw diameter, mass output, channel depth, rheology data of the formulation, and combinations thereof.

20. The process of claim 16, wherein the formulation is provided by a preprocessing apparatus (9) selected from mixing extruder, a heating apparatus and a kneader, wherein the preprocessing apparatus (9) receives a raw materials or unrefined pellets selected from soap or synthetic detergent pellets, and combinations thereof, and obtains the formulation.
